(19) United States
(12) Patent Application Publication
(10) Pub. No.: US 2016/0268563 A1
(43) Pub. Date: Sep. 15, 2016

(54) HYBRID POWER RAIL VEHICLE POWER SUPPLY BOX AND HYBRID POWER RAIL VEHICLE

(71) Applicant: CRRC TANGSHAN CO., LTD., Tangshan (CN)

(72) Inventors: LIEWEI HUANG, TANGSHAN (CN); MINGGAO LI, TANGSHAN (CN); MING LI, TANGSHAN (CN); GUOQING LI, TANGSHAN (CN); BIN LIU, TANGSHAN (CN); LU HAN, TANGSHAN (CN); FANBING KONG, TANGSHAN (CN); JUNJIE SHI, TANGSHAN (CN); NAN SHAO, TANGSHAN (CN)

(21) Appl. No.: 15/163,627

(22) Filed: May 24, 2016

Related U.S. Application Data
(63) Continuation of application No. PCT/CN2014/090377, filed on Nov. 5, 2014.

(30) Foreign Application Priority Data
Nov. 25, 2013 (CN) 201310606690.0

(51) Int. Cl. H01M 2/10; H01M 10/663; H01M 10/613; H01M 10/625; B61C 3/00; B61C 17/06

(52) U.S. Cl. CPC H01M 2/1083; B61C 3/00; B61C 17/06; H01M 10/613; H01M 10/625; H01M 10/663

(57) ABSTRACT

The present invention provides a hybrid power rail vehicle power supply box and a hybrid power rail vehicle. The hybrid power rail vehicle power supply box includes: a closed box body (10); a blowing pipe (2) that is fixedly arranged on one side outside the box body (10), is provided with an inlet (21) and at least one blowing branch pipe (22), and is communicated with the box body (10); a discharging pipe (3) that is fixedly arranged on other side outside the box body (10), is provided with an outlet and at least one discharging branch pipe (32), and is communicated with the box body (10) via the discharging branch pipe (32). The hybrid power rail vehicle power supply box can effectively cool the power supply box, protecting the power pack inside thereof, and satisfying outside mounting requirements of the vehicle.

### CROSS-REFERENCE TO RELATED APPLICATIONS

This application is a continuation of International Application No. PCT/CN2014/090377 filed on Nov. 5, 2014, which claims the priority benefit of China Patent Application No. 201310606690.0 filed on Nov. 25, 2013. The contents of the above identified applications are incorporated herein by reference in their entireties.

### TECHNICAL FIELD

The present invention relates to a rail vehicle manufacturing technology, and more particularly to a hybrid power rail vehicle power supply box and a hybrid power rail vehicle.

### BACKGROUND

In a hybrid power rail vehicle, a power supply box is generally provided on top of the vehicle body, and when the vehicle runs on a track section where no power grid is erected, a storage battery within the power supply box coordinates with a supercapacitor to provide tractive power for the vehicle; in this way, integrated optimization of various power performances can be achieved.

However, during frequent charging and discharging, the storage battery pack generates a lot of heat and has uneven temperature distribution within the power supply box. This often causes reduction in charging and discharging performances and capacity of the battery pack, or failures in the battery pack, and inconsistency of voltages or temperatures in branches. The commonly-used forced air cooling solution does not satisfy requirements of the protection level of the vehicle because the power supply box is arranged on top of the vehicle, and thus there is a need to cool the power supply box.

In the prior art, the cooling manner is to provide a cooling fan within the box body of the power supply box, and an intake grille in a shutter form on the box body, so as to drive airflow through the intake grille for exchange by rotating the fan and achieve forced air cooling.

However, since the power supply box is provided outside the vehicle body, in raining or snowing weather conditions, water drops tend to enter the power supply box via the intake grille. Besides, in spring, blowballs of poplar and willow trees or the like also can enter the power supply box via the intake grille, and such foreign substances are highly detrimental to operation safety of the device.

### SUMMARY

To overcome the shortcomings above, the present invention provides a hybrid power rail vehicle power supply box and a hybrid power rail vehicle. The present invention can achieve effective cooling of the power supply box, improvement of protection performance of the power supply box and thereby guarantee of safety operation.

The present invention provides a hybrid power rail vehicle power supply box, including: a closed box body with an accommodating cavity formed therein, and a power pack accommodated within the box body; a blowing pipe fixedly arranged on one side outside the box body, wherein, the blowing pipe is provided with an inlet for inflow of a cooling gas and at least one blowing branch pipe, and the blowing pipe is communicated with the box body via the blowing branch pipe; a discharging pipe fixedly arranged on other side outside the box body, wherein, the discharging pipe is provided with an outlet for outflow of the gas having absorbed heat and at least one discharging branch pipe, and the discharging pipe is communicated with the box body via the discharging branch pipe at the side facing away from the blowing branch pipe.

The present invention also provides a hybrid power rail vehicle, including: a vehicle body, an air-conditioner blowing system and the hybrid power rail vehicle power supply box provided on the vehicle body as described herein; wherein, an inlet of the blowing pipe of the power supply box and an outlet of the discharging pipe of the power supply box are communicated with the air-conditioner blowing system.

In the hybrid power rail vehicle power supply box provided in the present invention, by means of a closed box body provided with a blowing pipe and a discharging pipe, the cooling gas in the air conditioning system can be utilized to effectively cool the power supply box, so that the power supply box can operate normally with no fault, and meanwhile, the design of such closed structure can effectively protect power pack inside thereof, thereby satisfying outside mounting requirements of the vehicle, preventing impurities, such as water, dust, and blowballs of willow trees from being detrimental to the operating safety, and effectively improving the protection level of the power supply box.

### BRIEF DESCRIPTION OF DRAWINGS

FIG. 1 is a structural schematic diagram of a hybrid power rail vehicle power supply box according to an embodiment of the present invention;

FIG. 2 is a structural schematic diagram of a hybrid power rail vehicle power supply box according to another embodiment of the present invention; and

FIG. 3 is a structural schematic diagram of a hybrid power rail vehicle power supply box according to still another embodiment of the present invention.

### DESCRIPTION OF EMBODIMENTS

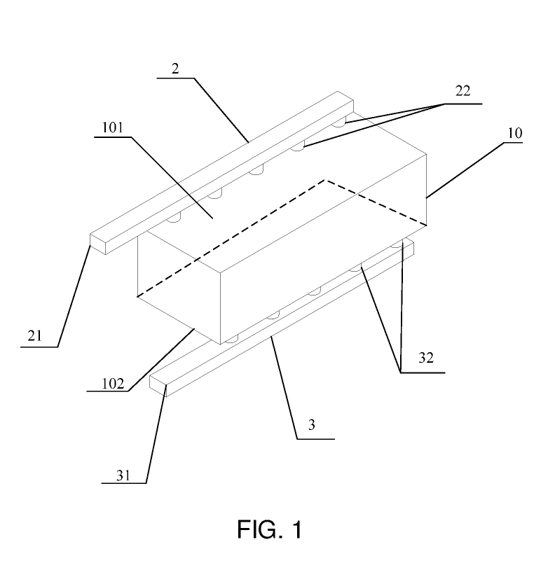

FIG. 1 is a structural schematic diagram of a hybrid power rail vehicle power supply box according to an embodiment of the present invention; referring to FIG. 1, this embodiment provides a hybrid power rail vehicle power supply box, including: a closed box body 10 with an accommodating cavity formed therein, and a power pack accommodated within the box body; a blowing pipe 2 fixedly arranged on one side outside the box body 10, wherein, the blowing pipe 2 is provided with an inlet 21 for inflow of a cooling gas and at least one blowing branch pipe 22, and the blowing pipe 2 is communicated with the box body 10 via the blowing branch pipe 22; a discharging pipe 3 fixedly arranged on other side outside the box body 10, wherein, the discharging pipe 3 is provided with an outlet 31 for outflow of the gas having absorbed heat and at least one discharging branch pipe 32, and the discharging pipe 3 is communicated with the box body 10 via the discharging branch pipe 32 at the side facing away from the blowing branch pipe 22.

Specifically, the box body 10 can be a casing in a cuboid shape or other irregular shapes, an accommodating cavity for accommodating a power pack can be formed therein; wherein, the power pack described above can be a storage battery and/or a supercapacitor. The blowing pipe 2 and the discharging pipe 3 can be located on two opposite sides of the box body 10, for example, the blowing pipe 2 can be located above the top of the box body, and connected to the top surface of the box body 10 via the blowing branch pipe 22, and meanwhile, the discharging pipe 3 can be located below the base plate of the box body 10, and connected to the bottom surface of the box body 10 via the discharging branch pipe 32; alternatively, the blowing pipe 2 and the discharging pipe 3 can be located on the left and right sides thereof, respectively, and the blowing branch pipe 22 and the discharging branch pipe 32 also can be connected to the left and right sides of the box body 10, respectively.

The blowing pipe 2 and the discharging pipe 3 can be a hollow straight pipe that is closed at one end and open at the other end, the open end can accordingly form an inlet 21 of the blowing pipe 2 and an outlet 31 of the discharging pipe 3; there can be one or more blowing branch pipes 22, one end of the blowing branch pipe 22 is communicated with the blowing pipe 2 and the other end thereof is communicated with the box body 10, so that the gas entering the blowing pipe 2 via the inlet 21 can enter the accommodating cavity within the box body 10 only via the blowing branch pipe 22, and meanwhile, the gas within the accommodating cavity can outflow only from the discharging branch pipe 32 and the discharging pipe 3 via the outlet 3.

The hybrid power rail vehicle power supply box provided in this embodiment can be mounted on top of the outer side of the vehicle body when it is used on the hybrid power rail vehicle; the inlet 21 of the blowing pipe 2 can be connected to a blowing pipeline of the air conditioning system of the hybrid power rail vehicle, so that the outlet of the discharging pipe 3 can be connected to a return air pipeline of the air conditioning system of the hybrid power rail vehicle; then, the cooling gas in the air conditioning system of the hybrid power rail vehicle enters the box body 10 at one side via the blowing pipe 2 from the blowing pipeline, and forms high-temperature gas when passing through the power pack and absorbing the heat released by the power pack during operation, the high-temperature gas outflows from the discharging pipe 3 and returns to the air conditioning system of the hybrid power rail vehicle via the return air pipeline.

In the hybrid power rail vehicle power supply box provided in this embodiment, by means of a closed box body provided with a blowing pipe and a discharging pipe, the cooling gas in the air conditioning system can be utilized to effectively cool the power supply box, so that the power supply box can operate normally with no fault, and meanwhile, the design of such closed structure can effectively protect the power pack therein, thereby satisfying outside mounting requirements of the vehicle, preventing impurities, such as water, dust, and blowballs of willow trees from being detrimental to the operating safety, and effectively improving the protection level of the power supply box.

Preferably, the blowing pipe 2 is provided with a fan for pressing a cooling gas into the box body 10; or the discharging pipe 3 is provided with a fan for extracting the gas having absorbed heat in the box body 10; therefore, gas circulation can be facilitated via the fan, to further improve cooling effect.

In an embodiment of the present invention, the box body 10 can be in a cuboid shape, and has a first sidewall 101 and an opposed second sidewall 102, the blowing branch pipe 22 is communicated with the first sidewall 101, and the discharging branch pipe 32 is communicated with the second sidewall 102; the number of each of the blowing pipe 2 and the discharging pipe 3 can be one; besides, the blowing pipe 2 and the discharging pipe 3 can extend in parallel; there are at least two blowing branch pipes 22 formed between the blowing pipe 2 and the first sidewall 101, and a plurality of the blowing branch pipes 22 can be arranged along a straight line at equal intervals; there are at least two discharging branch pipes 32 formed between the discharging pipe 3 and the second sidewall 102, and a plurality of the discharging branch pipes 32 can be arranged along a straight line at equal intervals.

Preferably, the blowing pipe 2 and the discharging pipe 3 may be arranged not opposite to each other, that is, projections of the blowing pipe 2 and the discharging pipe 3 on the first sidewall 101 or the second sidewall 102 are not overlapped, so as to increase the distance of the gas flowing through the box boxy 10, achieve sufficient heat exchange between the cooling gas and the power pack and improve a cooling effect.

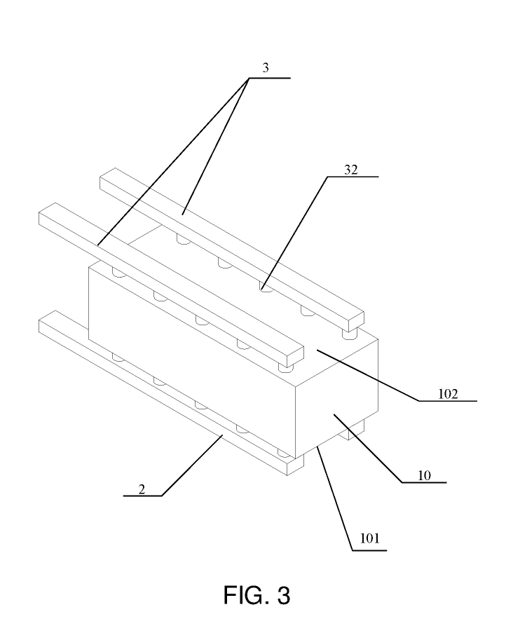

It should be noted that, when mounted, the first sidewall 101 can be mounted upward and the second sidewall 102 can be mounted downward onto the vehicle body, that is, a top blowing circulation mode can be formed; alternatively, the second sidewall 102 can be mounted upward and the first sidewall 101 can be mounted downward onto the vehicle body, that is, a bottom blowing circulation mode can be formed (as shown in FIG. 3).

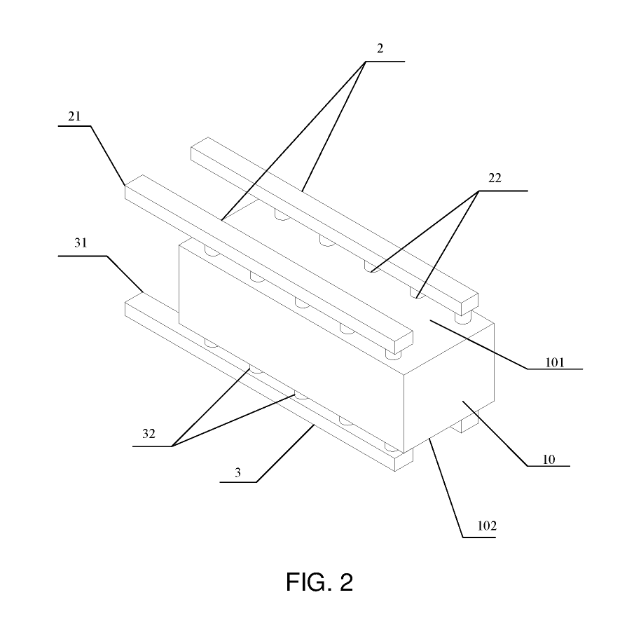

In another embodiment of the present invention, as shown in FIG. 2, the number of each of the blowing pipe 2 and the discharging pipe 3 can be at least two, and the at least two blowing pipes 2 and the at least two discharging pipes 3 are arranged in a one-to-one correspondence manner Preferably, the blowing pipe 2 and the discharging pipe 3 can be two; each of the blowing pipes 2 and each of the discharging pipes 3 extend in parallel; there are at least two blowing branch pipes 22 formed between each of the blowing pipes 2 and the first sidewall 101, and there are at least two discharging branch pipes 32 formed between each of the discharging pipes 3 and the second sidewall 102; each of the blowing branch pipes 22 communicated with the same blowing pipe 2 and each of the discharging branch pipes 32 communicated with the corresponding discharging pipe 3 are arranged in a one-to-one correspondence manner

Another embodiment of the present invention provides a rail vehicle, including: a vehicle body, an air-conditioner blowing system and the hybrid power rail vehicle power supply box, provided on the vehicle body as described in any one of the above embodiments; wherein, an inlet of the blowing pipe of the power supply box and an outlet of the discharging pipe of the power supply box are communicated with the air-conditioner blowing system, that is, the blowing pipe is communicated with the blowing pipeline of the air-conditioning system, and the discharging pipe is communicated with the discharging pipeline of the air-conditioning system, so that cooling medium of the air-conditioning system can be partially drained to the power supply box, so as to form a circulation branch for cooling the power supply.

In the hybrid power rail vehicle power supply box provided in this embodiment, the power supply box is provided with a closed box body having a blowing pipe and a discharging pipe, and utilizes the cooling gas in the air conditioning system to effectively cool the power supply box, so that the power supply box can operate normally with no fault, and meanwhile, the design of such closed structure can effectively protect the power pack inside thereof, thereby satisfying outside mounting requirements of the vehicle, preventing impurities, such as water, dust, and blowballs of willow trees from being detrimental to the operating safety, and effectively improving the protection level of the power supply box.

Finally, it should be noted that the above embodiments are merely provided for describing the technical solutions of the present invention, but not intended to limit the present invention. It should be understood by persons skilled in the art that although the present invention has been described in detail with reference to the foregoing embodiments, modifications can be made to the technical solutions described in the foregoing embodiments, or equivalent replacements can be made to part or all of the technical features in the technical solutions; such modifications or replacements will not cause the essence of corresponding technical solutions to depart from the scope of the present invention.

What is claimed is:

1. A hybrid power rail vehicle power supply box, comprising: a closed box body with an accommodating cavity formed therein, and a power pack accommodated within the box body; a blowing pipe fixedly arranged on one side outside the box body, wherein, the blowing pipe is provided with an inlet for inflow of a cooling gas and at least one blowing branch pipe, and the blowing pipe is communicated with the box body via the blowing branch pipe; a discharging pipe fixedly arranged on other side outside the box body, wherein, the discharging pipe is provided with an outlet for outflow of the gas having absorbed heat and at least one discharging branch pipe, and the discharging pipe is communicated with the box body via the discharging branch pipe at the side facing away from the blowing branch pipe.

2. The hybrid power rail vehicle power supply box according to claim 1, wherein, the box body is in a cuboid shape, and comprises a first sidewall and an opposed second sidewall, the blowing branch pipe is communicated with the first sidewall, and the discharging branch pipe is communicated with the second sidewall.

3. The hybrid power rail vehicle power supply box according to claim 2, wherein, the number of both the blowing pipe and the discharging pipe are one.

4. The hybrid power rail vehicle power supply box according to claim 3, wherein, the blowing pipe and the discharging pipe extend in parallel; there are at least two blowing branch pipes formed between the blowing pipe and the first sidewall, and there are at least two discharging branch pipes formed between the discharging pipe and the second sidewall.

5. The hybrid power rail vehicle power supply box according to claim 2, wherein, the number of each of the blowing pipe and the discharging pipe is at least two, and the at least two blowing pipes and the at least two discharging pipes are arranged in a one-to-one correspondence manner.

6. The hybrid power rail vehicle power supply box according to claim 5, wherein, each of the blowing pipes and each of the discharging pipes extend in parallel; there are at least two blowing branch pipes formed between each of the blowing pipes and the first sidewall, and there are at least two discharging branch pipes formed between each of the discharging pipes and the second sidewall; each of the blowing branch pipes communicated with the same blowing pipe and each of the discharging branch pipes communicated with the corresponding discharging pipe are arranged in a one-to-one correspondence manner.

7. The hybrid power rail vehicle power supply box according to claim 1, wherein, the blowing pipe is provided with a fan for pressing a cooling gas into the box body; or
the discharging pipe is provided with a fan for extracting the gas having absorbed heat in the box body.

8. A hybrid power rail vehicle, comprising: a vehicle body, an air-conditioner blowing system and the hybrid power rail vehicle power supply box provided on the vehicle body according to claim 1; wherein, an inlet of the blowing pipe of the power supply box and an outlet of the discharging pipe of the power supply box are communicated with the air-conditioner blowing system.
